(19) United States
(12) Patent Application Publication
(10) Pub. No.: US 2023/0313857 A1
(43) Pub. Date: Oct. 5, 2023

(54) LEAF SPRING THAT PROVIDES MULTIPLE SPRING RATES

(71) Applicant: OLGUN CELIK SANAYI VE TICARET ANONIM SIRKETI, Manisa (TR)

(72) Inventors: Mehmet Ozgur ARSLAN, Manisa (TR); Gediz KULAC, Manisa (TR)

(73) Assignee: OLGUN CELIK SANAYI VE TICARET ANONIM SIRKETI, Manisa (TR)

(21) Appl. No.: 18/022,527

(22) PCT Filed: Sep. 28, 2020
(86) PCT No.: PCT/TR2020/050891

§ 371 Date: Feb. 22, 2023

(51) Int. Cl. F16F 1/22; F16F 3/12; F16F 1/26; F16F 3/02

(52) U.S. Cl. CPC F16F 1/22; F16F 3/12; F16F 1/26; F16F 3/023; F16F 2228/066; F16F 2238/022; B60G 11/04

(57) ABSTRACT

A leaf spring structure is designed as a single piece to be able to change the spring rates of leaf springs under a load independently from the manufacturing material. The operating mechanism of the leaf spring allows for increasing the spring rates by deactivating the short spring, which remains between the point A and the point B, as a result of the interaction between the short spring and the long spring after a certain amount of vertical displacement in the leaf spring.

### CROSS REFERENCE TO THE RELATED APPLICATIONS

This application is the national phase entry of International Application No. PCT/TR2020/050891, filed on Sep. 28, 2020, the entire contents of which are incorporated herein by reference.

### TECHNICAL FIELD

The present invention relates to a leaf spring structure designed as a single piece to be able to change the spring rate of leaf springs under load independently from the manufacturing material. The present invention particularly rate relates to an operating mechanism that is capable of increasing the spring rate as a result of the interaction between the short spring and the long spring after a certain vertical displacement while the short spring and the long spring, which are the two regions of the leaf spring, are operating together.

### BACKGROUND

In the state of the art, the spring rate of the spring should increase as shown in FIG. 1 as a result of the vertical displacement increase during the use of leaf springs. Nowadays, various applications are implemented in order to increase the spring rate of leaf springs.

Leaf springs that are commonly used in the state of the art feature the form shown in FIG. 2, and they comprise an auxiliary layer located below the main layer of the leaf spring. When a specific amount of load is imposed on the leaf spring, the auxiliary layer becomes activated after a certain amount of displacement. While the main layer of the spring has a specific spring rate up to a certain amount of displacement, said the main layer comes into contact with the auxiliary layer of the leaf spring once the displacement threshold is exceeded, and accordingly, the spring rate thereof increases. Thus, different spring rates may be obtained for different displacements, and the force-displacement curve shown in FIG. 1 may be achieved.

However, auxiliary layers used in leaf springs increase the weight of leaf springs, and correspondingly, they increase the overall weight of the vehicle, thereby increasing the carbon emission. In addition, leaf springs with multiple layers generate vibrations while driving and cause chassis fatigue. Furthermore, materials used during the assembly of the main layer and the auxiliary layer induce strength losses.

The preliminary search conducted in the state of the art has shown that the technical content of the patent application numbered TR2015/10669 mentions a spring shackle integrated into at least one of the ends of the leaf spring as shown in FIG. 3, and a gummy bumper is fixed to the end of said spring shackle. In case the displacement threshold is exceeded, the gummy bumper located on the spring shackle comes into contact with the leaf spring, thereby increasing the available spring rate. The force-displacement chart shown in FIG. 1 may be obtained through this design. However, the force applied by the gummy bumper causes permanent deformations in the leaf spring over time and causes fatigue. This results in frequent replacements for the leaf spring.

The preliminary search conducted in the state of the art has shown that the technical content of the patent application numbered GB585984A mentions that the laminated leaf spring system designed as shown in FIG. 4 comprises auxiliary layers positioned in a flat position below the main leaves and retained by fasteners. Auxiliary layers of the system are manufactured from a more rigid material compared to the leaf springs. In the patent application numbered GB585984A, in case the displacement threshold of the C shape at the end portions of the leaf spring is exceeded, it does not contact the main body of the leaf spring, and said C-shaped end portions are used for mounting the leaf spring to the chassis. In case the displacement threshold is exceeded, layers located at the upper portion come into contact with flat layers located at the lower portion. Thus, the force-displacement chart shown in FIG. 1 is obtained. Using fasteners and a leaf spring with more layers in this design increases the weight of the vehicle, thereby increasing the carbon emission. Additionally, using layers consisting of two materials in the production of leaf springs increases the manufacturing costs.

In the state of the art, there are various applications in which the spring rate is changed by using a single leaf spring. Such applications create a contact point with the vehicle chassis. The leaf spring comes into contact with the contact point on the chassis as a result of exceeding the displacement threshold due to the load imposed on the leaf spring, thereby increasing the spring rate. However, such use is not suitable for every vehicle type. In case it is indeed suitable, it incurs additional costs since it requires installing an additional part. Furthermore, the additional part positioned on the chassis generates a continuous impact on the leaf spring as the vehicle shakes, thereby inducing fatigue and deformation in the material of the leaf spring.

### SUMMARY

The present invention relates to leaf springs comprising a C spring designed so as to eliminate all the disadvantages in the state of the art. The object of the inventive leaf spring is to provide multiple spring rates independently of the manufacturing material by means of the improved design of the leaf spring.

The present invention allows for producing leaf springs from a single material, thereby reducing the amount of material used for manufacturing. Thus, the present invention is not only cost-saving but also allows for obtaining a product that is lighter when compared to multi-layered leaf springs used for obtaining similar varying spring rates. The present invention also reduces the carbon emission of the vehicle in which it is used, as it is lighter compared to leaf spring designs of the state of the art that comprise multiple layers.

The innovative geometric design of the inventive leaf spring allows for using the leaf spring without the need for replacing or interfering with a vehicle's available parts. In addition thereto, the present invention avoids strength losses occurring while mounting the additional layers since the inventive leaf spring is manufactured as a single piece. The present invention allows for eliminating undesired consequences in the state of the art such as the abrasion and/or fatigue of the material stemming from vibration-induced collision of the multi-layered leaf springs.

The main body of the inventive leaf spring does not sustain any damage as the inventive leaf spring does not utilize any products like gummy bumpers, etc. in order to change the spring rate. Thus, when the inventive leaf spring is installed on a vehicle, it may have a prolonged lifetime.

### BRIEF DESCRIPTION OF THE DRAWINGS

The inventive leaf spring that provides multiple spring rates should be evaluated in light of the following figures in order to ensure that the innovations made to achieve the aforementioned objects are understood clearly,

Wherein;

FIG. 1 illustrates the representative force-displacement chart of leaf spring with a variable spring rate.

FIG. 2 illustrates the leaf spring view of the state of the art.

FIG. 3 illustrates the leaf spring view of the state of the art.

FIG. 4 illustrates the leaf spring view of the state of the art.

FIG. 5 illustrates the force-displacement chart of the k₁ spring rate of the inventive leaf spring.

FIG. 6 illustrates the free form of the inventive leaf spring.

FIG. 7 illustrates the inventive leaf spring in the interaction value.

FIG. 8 illustrates the inventive leaf spring in the loading state after the interaction.

FIG. 9 illustrates the view for the alternative bumper use view of the inventive leaf spring at the A point.

FIG. 10 illustrates the view for the alternative bumper use of the inventive leaf spring at the B point.

FIG. 11 illustrates the view of alternative use of the inventive leaf spring. wherein the vehicle connection is made by the spring shackle.

FIG. 12 illustrates the view of alternative use of the inventive leaf spring, wherein the vehicle connection is made by the spring eye and the spring shackle.

FIG. 13 illustrates the view of alternative use of the inventive leaf spring; wherein the vehicle connection is made by a vehicle chassis connection clamp.

FIG. 14 illustrates the view of an alternative design of the inventive leaf spring, wherein said leaf spring has a curved shape.

FIG. 15 illustrates the view of an alternative design of the inventive leaf spring, wherein said leaf spring has a triple spring rate.

FIG. 16 illustrates the view of the inventive leaf spring flexing under the load imposed thereon.

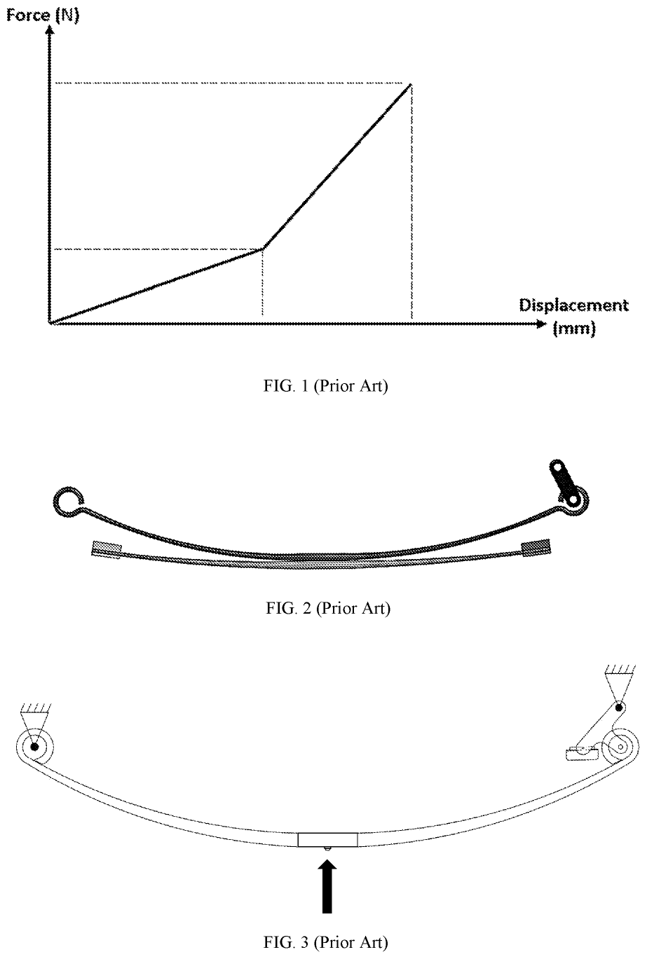

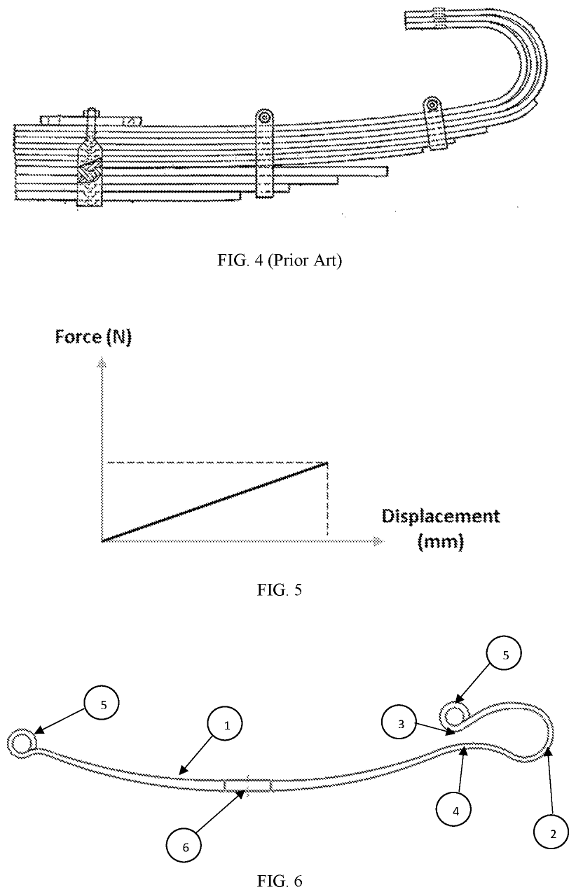

Respective components of the inventive leaf spring that provides multiple spring rates are enumerated in said figures in order to provide a better understanding of the present invention

Wherein;
1. Long Spring
2. Short Spring
3. Point A
4. Point B
5. Chassis Connection Area
6. Axle Shaft Connection Area
7. Bumper
8. Spring Shackle
9. Chassis Connection Clamp
10. Auxiliary Layer
11. Spring Eye

### DETAILED DESCRIPTION OF THE EMBODIMENTS

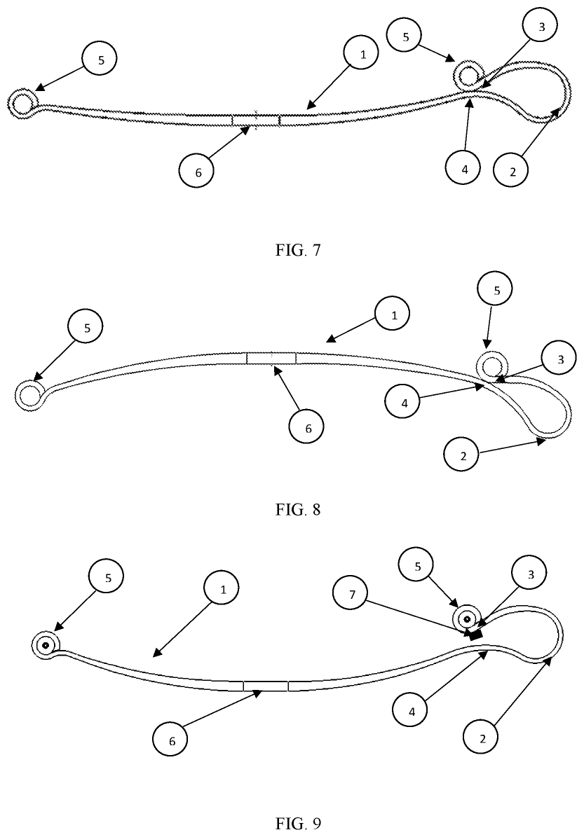

The present invention is a leaf spring designed as a vehicle suspension element, and it is based on the parallel operation of areas with different spring rates. The inventive single-piece leaf spring comprises a long spring (1) and a short spring (2). Definitions of the long spring (1) and the short spring (2) are based on the geometrical shapes thereof and said long spring (1) and short spring (2) constitute the two different regions of the same spring. Chassis connection areas (5) serving as areas for connecting the leaf spring to the vehicle chassis are located at both ends of the leaf spring, i.e. at the end portions of the long spring (1) and the short spring (2). (FIG. 6)

The spring rate of the inventive leaf spring is based on the resultant value of spring rates of said long spring (1) and short spring (2) up to the determined displacement value. Spring rates of both the long spring (1) and the short spring (2) depend on the geometric characteristics and material properties thereof. A force-displacement chart pertaining to the spring rate value up to the determined displacement value of the leaf spring is obtained as illustrated in FIG. 5. Upon exceeding the determined displacement value, a point B (4) on the long spring (1), and a point A (3) on the short spring (2) interact with one another. (FIG. 7) Point A (3) and point B (4) are the predetermined interaction points on the long spring (1) and the short spring (2). Geometrical shapes assumed by the long spring (1), short spring (2), point A (3), and point B (4) that are loaded subsequent to the interaction therebetween once the critical displacement value of the leaf spring is exceeded are illustrated in FIG. 8.

Subsequent to the interaction of the point B (4) on the long spring (1) and the point A (3) on the short spring (2), the point B (4) on the long spring (1) serves as a point of support and eliminates the influence of the spring rate of the short spring (2) on the total spring rate almost completely. The unique aspect of the present invention is that it is capable of achieving a different spring rate by directly interacting with the single-piece leaf spring. Thus, the desired force-displacement chart may be obtained by merely changing the geometry and/or the material properties of the short spring (2) and/or the long spring (1) without the need for any external point of support in addition to the spring. The present invention is described with an example given below in order to provide a better understanding of the inventive product.

### Spring Rate (kT) of the Leaf Spring Prior to Exceeding the Critical Displacement Value:

$$\frac{1}{kT} = \frac{1}{k 1} + \frac{1}{k 2} \to kT = \frac{k 1 * k 2}{k 1 + k 2}$$

### Spring Rate (kT) of the Leaf Spring After the Displacement Threshold is Exceeded:

kT≅k1
(Spring Rate of the Long Spring (1) is Denoted by “k1”, and the Spring Rate of the Short Spring (2) is Denoted by “k2”.)

### EXAMPLE

Spring Rate k1 of the Long Spring (1): 80 N/mm
Spring Rate k2 of the Short Spring (2): 120 N/mm
Displacement Value from the No-Load Position to the Self-Interaction Position: 100 mm
Maximum Displacement Value: 200 mm

$$\begin{matrix}{k}_{T 1} = \frac{80 * 120}{80 + 120} = 48 N / mm & ( Displacement Value < 100 mm )\end{matrix} \\ \begin{matrix}{k}_{T 2} ≅ 80 N / mm & ( 100 mm < Displacement Value < 200 mm )\end{matrix}$$

As shown in the example above, in cases where the displacement value is not exceeded, spring rates of the long spring (1) and the short spring (2) function as if they are connected in parallel to one another and accordingly, the resultant spring rate takes a smaller value. On the other hand, in cases where the critical displacement value is exceeded, the point A (3) interacts with the point B (4), and the short spring (2) is disabled as a result of this interaction. Thus, the total spring rate of the leaf spring roughly equals the spring rate of the long spring (1), thereby increasing the total spring rate. Accordingly, the force-displacement chart shown in FIG. 1 may be obtained by means of a single leaf spring.

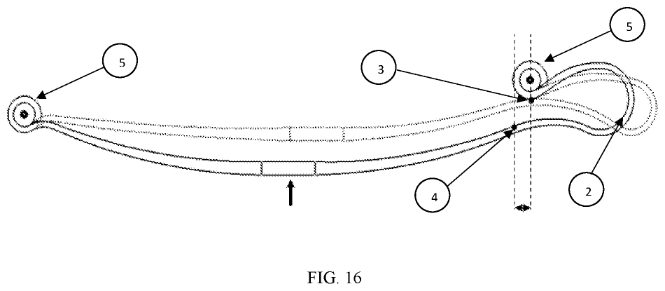

Another technical problem solved by the present invention is eliminating the use of spring shackles on leaf springs. In the state of the art, the length of the leaf spring increases due to the stretching of the leaf spring under load. Using spring shackles in at least one chassis connection area is necessary in order to tolerate this increase in length. The illustration provided in FIG. 16 shows the stretching of the leaf spring under force in the present invention. In the present invention, the elongation stemming from the stretching of the leaf spring is tolerated by means of bending of the short spring (2), thereby ensuring that both chassis connection areas (5) of the leaf spring remain stable and connected to the chassis.

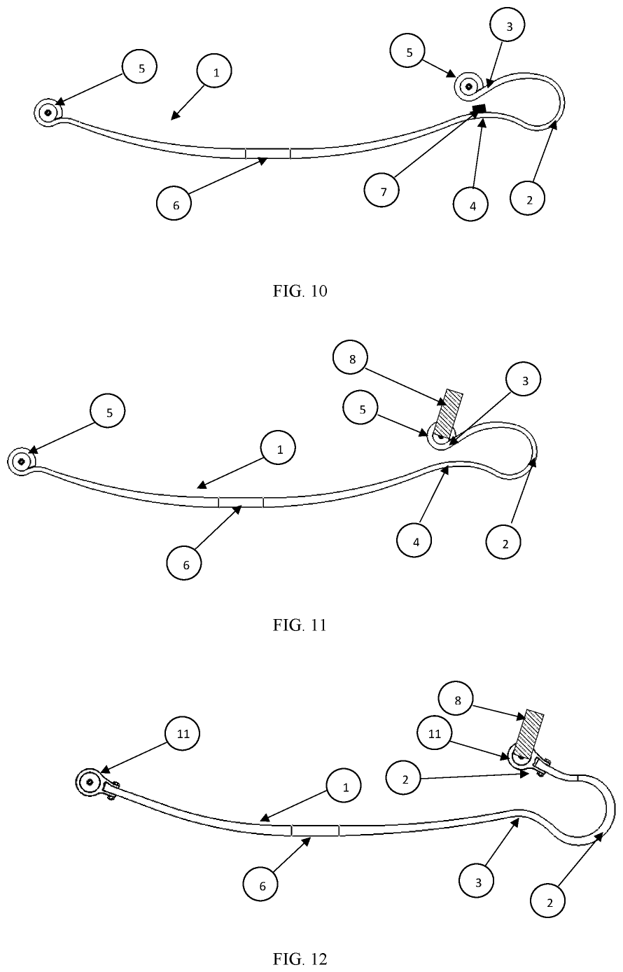

The present invention described above has alternative applications. As seen in FIG. 9, in addition to the present invention, a bumper (7) is mounted and fixed to the lower portion of the chassis connection area (5), i.e. the point A (3), positioned to the end of the short spring (2). Thus, the force generated during the interaction of point A (3) and point B (4) is distributed to a wider area, thereby preventing any potential local deformations. Analogously, said bumper (7) may be positioned to the point B (4), thereby ensuring that the force generated during the interaction of the point A (3) and point B (4) is distributed to a wider area. (FIG. 10)

In another application, a spring shackle (8) is connected to the chassis connection area (5) positioned to the end of the short spring (2). The end portion of the short spring (2) of the inventive leaf spring is connected to the chassis by means of the spring shackle (8). The spring shackle's (8) capability of rotating around its axis facilitates the short spring's (2) movement on the x-axis. Thus, the elongation stemming from the stretching occurring on the leaf spring under load may be tolerated.

As illustrated in FIG. 12, spring eyes (11) that allow assembly-disassembly with the leaf spring are connected to both ends of the leaf spring instead of the single-piece chassis connection area (5). Thus, replacing only the spring eyes (11) instead of an entire leaf spring would be enough in case the spring eyes (11) sustain any damage. A spring shackle (8) may be used to connect the spring eye (11) to the chassis based on user preference.

An alternative application is illustrated in FIG. 13, wherein the spring eye (11) is mounted on the end of the long spring (1) and the chassis connection clamp (9) is mounted at the end of the short spring (2). Chassis connection clamp (9) that may be assembled/disassembled may be used based on the preference of use.

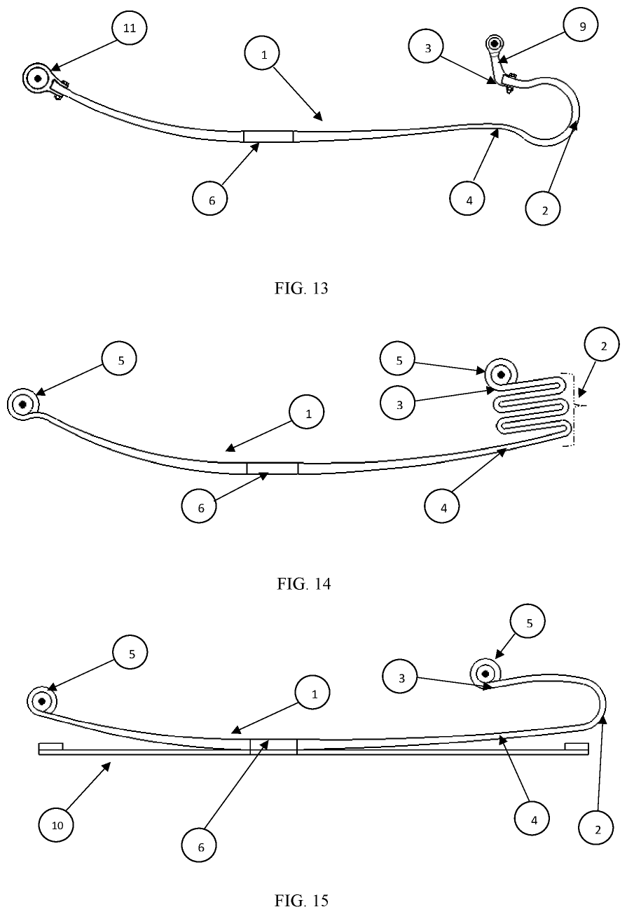

The essential point about the present invention is that, once the specified displacement value is exceeded, the short spring (2) is deactivated as a result of the interaction between the point A (3) and the point B (4). Accordingly, as illustrated in FIG. 14, more than one curve may be created on the geometric shape of the short spring (2). The operation principle of the leaf spring is independent of the geometric form of the short spring (2). As the short spring (2) that remains between the point A (3) and point B (4) may have a C shape, it may also be as illustrated in FIG. 14 or FIG. 15. In addition thereto, the geometric shape of the short spring (2) may also have an angular shape based on preference.

As illustrated in FIG. 15, a flat spring (10) is connected to the axle shaft connection area (6) of the leaf spring in order to obtain three different spring rates depending on the displacement value. This design allows for changing the total spring rate of the leaf spring both when the point A (3) interacts with the point B (4), and when the long spring (1) interacts with the flat spring (10). Thus, three different spring rates are obtained for different displacement values.

As the inventive leaf spring may be manufactured from a single material based on user preference, the long spring (1) and the short spring (2) may be manufactured from different materials. This varies depending on the total number of spring rates needed.

1. A leaf spring providing multiple spring rates, depending on displacement values, comprising:
at least one first point on a single leaf spring, and
at least one second point, wherein the at least one second point is located below the at least one first point, and is capable of interacting with the at least one first point as a result of stretching of the leaf spring under a load.

2. The leaf spring according to claim 1, further comprising at least one bumper positioned on the at least one first point.

3. The leaf spring according to claim 1, further comprising at least one bumper positioned on the at least one second point.

4. The leaf spring according to claim 1, further comprising at least one spring shackle, wherein the at least one spring shackle is connected to a chassis connection area located on an end portion of a short spring.

5. The leaf spring according to claim 1, further comprising at least one spring eye, wherein the at least one spring eye is mounted on each end of the leaf spring, and allows assembly/disassembly.

6. The leaf spring according to claim 5, further comprising at least one spring shackle connected to the at least one spring eye.

7. The leaf spring according to claim 1, further comprising at least one chassis connection clamp connected to at least one end the leaf spring.

8. The leaf spring according to claim 1, further comprising a short spring, wherein the short spring remains between the at least one first point and the at least one second point has a C shape.

9. The leaf spring according to claim 1, further comprising a short spring, wherein the short spring remains between the at least one first point and the at least one second point and has a U shape.

10. The leaf spring according to claim 1, further comprising a short spring, wherein the short spring remains between the at least one first point and the at least one second point and has multiple curves.

11. The leaf spring according to claim 1, further comprising a short spring, wherein the short spring remains between the at least one first point and the at least one second point and has an angular shape.

12. The leaf spring according to claim 1, further comprising at least one flat spring, wherein the at least one flat spring is connected to the leaf spring, and allows for obtaining three different spring rates.
